(19) United States
(12) Patent Application Publication
(10) Pub. No.: US 2003/0051863 A1
(43) Pub. Date: Mar. 20, 2003

(54) Heat pipe system for heat reduction in automobiles

(76) Inventor: Scott D. Garner, Lititz, PA (US)

Correspondence Address: DUANE MORRIS, LLP, ATTN: WILLIAM H. MURRAY, ONE LIBERTY PLACE, 1650 MARKET STREET, PHILADELPHIA, PA, 19103-7396, US

(21) Appl. No.: 10/272,818

(22) Filed: Oct. 17, 2002

Related U.S. Application Data
(62) Division of application No. 09/776,741, filed on Feb. 5, 2001.

(51) Int. Cl. B60H 3/00; F28D 15/00

(52) U.S. Cl. 165/104.19; 165/42

(57) ABSTRACT

A heat pipe system for an automobile comprising: a separator layer, at least one wick layer in contact with the separator layer, at least two outer walls enclosing the separator layer and the at least one wick layer, one of the at least two outer walls being spaced away from the at least one wick layer to form a vapor space therebetween.

### FIELD OF THE INVENTION

The present invention relates to a method and apparatus for reducing the interior temperature of automobile cabins by employing a heat pipe system.

### DESCRIPTION OF THE RELATED ART

A basic heat pipe comprises a closed or sealed envelope or a chamber containing an isotropic liquid-transporting wick and a working fluid capable of having both a liquid phase and a vapor phase within a desired range of operating temperatures. When one portion of the chamber is exposed to relatively high temperature it functions as an evaporator section. The working fluid is vaporized in the evaporator section causing a slight pressure increase forcing the vapor to a relatively lower temperature section of the chamber defined as a condenser section. The vapor is condensed in the condenser section and returned through the liquid-transporting wick to the evaporator section by capillary pumping action.

Because it operates on the principle of phase changes rather than on the principles of conduction or convection, a heat pipe is theoretically capable of transferring heat at a much higher rate than conventional heat transfer systems. Consequently, heat pipes have been utilized to cool various types of high heat-producing apparatus, such as electronic equipment (See, e.g., U.S. Pat. Nos. 5,884,693, 5,890,371, and 6,076,595).

Traditional heat pipes are constructed with rigid metal casings and internal sintered wicks which, after manufacture, are expected to remain in essentially the same configuration as when they were originally manufactured. Some such heat pipes have been constructed with thin casings to permit some reconfiguration, and there have been a number of patents for heat pipes which include flexible segments to enable repeated bending of certain parts of the heat pipe.

There are also a number of patents which have issued for heat pipes which are considered to be flexible in that their entire casings are constructed of thin flexible materials. Some patents also describe wicks which are flexible. For example, U.S. Pat. No. 5,560,423 to Larson et al. discloses a flexible heat pipe 10 with a thin metal sheet forming one side of a heat pipe casing, and a thin plastic sheet for the other side of the casing, with sheet screen wicking between them. U.S. Pat. No. 5,343,940 to Jean discloses a flexible heat pipe 21 formed of laminated plastic material.

However, there is presently no available heat pipe system, flexible or otherwise, for cooling the interior cabin of an automobile. It is well known and understood that solar radiation from the sun tends to heat the interior cabins of automobiles, especially when the automobiles are left in one position for an extended period (e.g., in an uncovered parking lot while one is at work, shopping, etc.). It is also well known and understood that air conditioners are used to cool the interior cabins of automobiles, but that often times, because of heated air trapped in the automobile, or because of the prolonged startup time of an air conditioning units, it make take upwards of 5-15 minutes to cool the interior cabin of an automobile to an acceptable temperature.

Therefore, there is currently a need for a heat pipe system for effectively keeping cool, and cooling, the interior cabin of an automobile.

### SUMMARY OF THE INVENTION

The present invention is a heat pipe system for an automobile comprising: a separator layer, at least one wick layer in contact with the separator layer, at least two outer walls enclosing the separator layer and the at least one wick layer, one of the at least two outer walls being spaced away from the at least one wick layer to form a vapor space therebetween.

The above and other advantages and features of the present invention will be better understood from the following detailed description of the exemplary embodiments of the invention which is provided in connection with the accompanying drawings.

### BRIEF DESCRIPTION OF THE DRAWINGS

FIG. 1(a) is side elevation view showing a heat pipe according to a first exemplary embodiment of the present invention.

FIG. 1(b) is top plan view showing the heat pipe of FIG. 1(a).

FIG. 2 is side elevation view showing the heat pipe of FIGS. 1(a) and 1(b) installed in an automobile.

FIG. 3 is an enlarged cross sectional view of the heat pipe shown in FIGS. 1(a) and 1(b).

FIG. 4 is an enlarged cross sectional view of a heat pipe according to a second exemplary embodiment of the present invention.

FIG. 5 is an enlarged cross sectional view of a heat pipe according to a third exemplary embodiment of the present invention.

### DETAILED DESCRIPTION

A first exemplary embodiment of the present invention comprises a heat pipe structure 100 for reducing the interior temperature of automobiles. The heat pipe structure 100 reduces interior heat in two significant ways, by limiting the amount of solar radiation which is transferred to the automobile cabin, and by efficiently removing any heat trapped within the automobile cabin through a heat pipe. In particular, the heat pipe structure 100 acts as a thermal diode, by prohibiting heat entry in one direction (i.e., from the automobile roof to the automobile cabin), and by allowing heat exit in an opposing direction (i.e., from the automobile cabin to the roof).

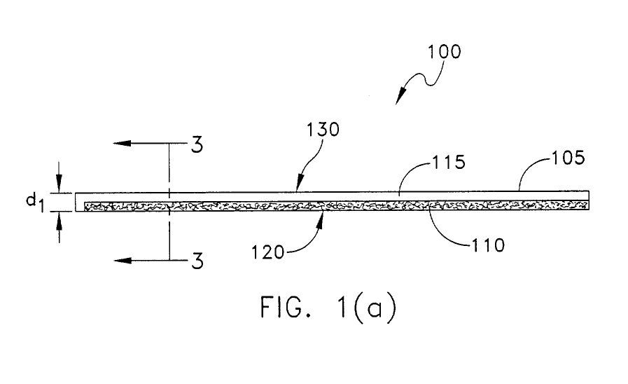

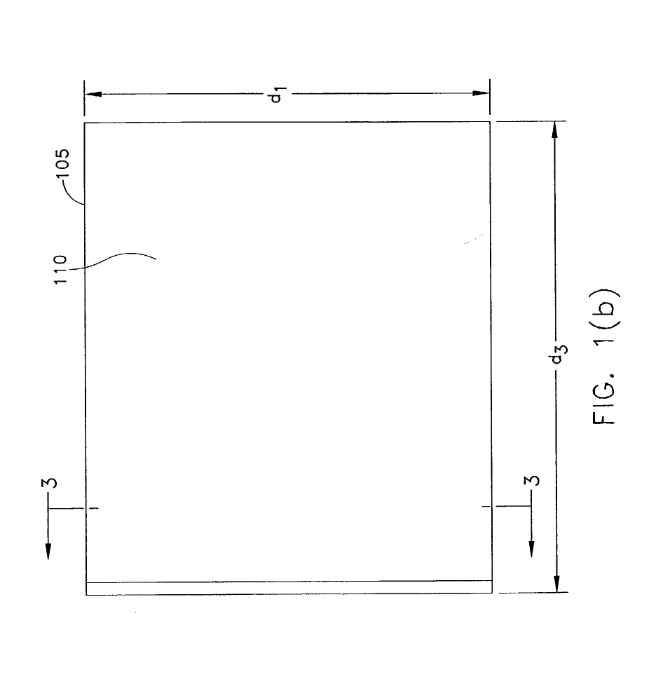

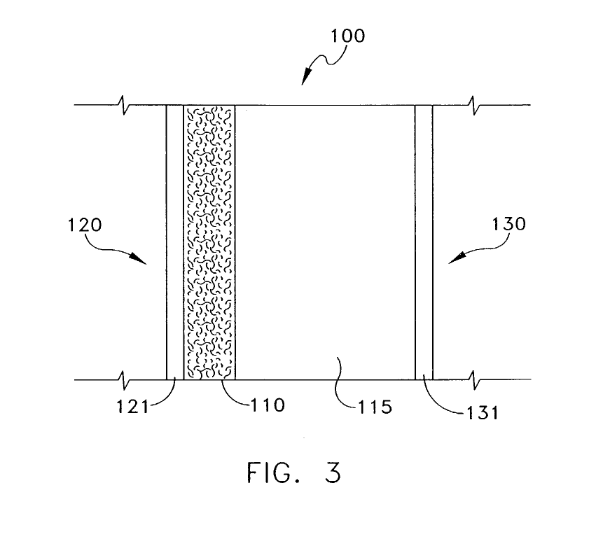

FIG. 1(a) shows a side view of the heat pipe structure 100 according to a first exemplary embodiment of the present invention. The heat pipe structure 100 comprises a housing 105, preferably made of metal (e.g., Copper (Cu)) which encases a wick structure 110 and which forms a vapor space 115 therebetween. A lower portion 120 of the housing 105 forms an evaporator section of the heat pipe structure 100, and an upper portion 130 of the housing 105 forms a condenser section of the heat pipe structure. As is well known in the art, the wick structure 110 may also be made of metal (e.g., Copper felt; see FIG. 3 description below), and saturated with a fluid which has both liquid and vapor phases (e.g., water). A height (d,) of the heat pipe structure 100 may be selected according to the heat dissipation requirements, but is preferably in a range from 1/8 inch to 1/4 inch.

FIG. 1(b) shows a top view of the heat pipe structure 100. The width (d₂) and length (d₃) of the heat pipe structure 100 may be selected based on the roof size of the automobile.

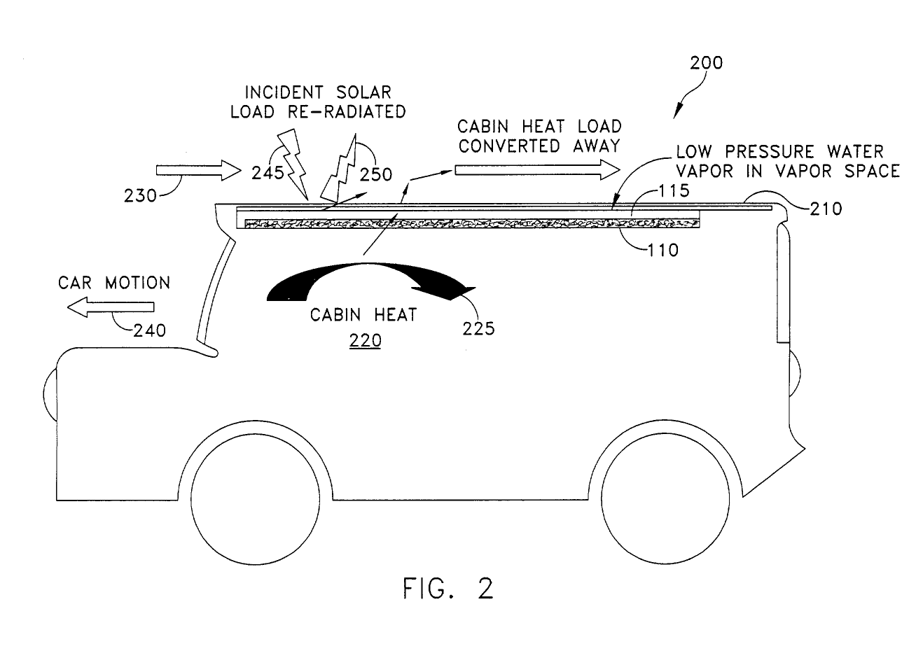

FIG. 2 shows an automobile 200 with the heat pipe structure 100 according to the exemplary embodiment of the present invention installed therein. The automobile includes a roof 210 and a cabin area 220 where passengers are seated when the automobile is in use. When the automobile is not in use (i.e., when it is sitting in a parking lot or otherwise), incident solar radiation 245 (i.e., from the sun) tends to produce heated air 225 inside the cabin area 220. However, when the car is in operation and moving in a direction 240, air passes across a top surface (i.e., roof 210) of the automobile in a direction 230.

The heat pipe structure 100 is attached beneath the roof 210 of the automobile 200, between the roof and the cabin area 220. The heat pipe structure 100 may be attached to the roof 210 in various ways, but is preferably attached through known attachment means (e.g., clips, screws, etc.) disposed at opposite ends of the heat pipe structure 100. In the exemplary embodiment, the heat pipe structure 100 includes at least four (4) such attachment means, one disposed at each corner of the rectangular housing 105 of the heat pipe structure 100.

In operation, the heat pipe structure 100 significantly reduces cabin heat 225 buildup, and quickly and efficiently dissipates any cabin heat. The heat pipe structure 100 reduces cabin heat 225 buildup by presenting a virtual vacuum to incident solar radiation 245 through vapor space 115. In particular, incident solar radiation 245 can only travel to the automobile cabin 220 through convection or conduction. Convection is substantially eliminated as a method of transferring the incident solar radiation 245 to the automobile cabin 220 by the vapor space 115 between the automobile roof 210 and the cabin. Additionally, conduction will only occur in those areas where the automobile roof 210 is directly connected to the cabin 220 (i.e., in the small areas where the heat pipe structure 100 is secured to the roof 210 of the automobile. Plastic attachments between the roof 210 and the heat pipe structure 100 may be used to further decrease the conduction of heat to the automobile cabin 220.

The heat pipe structure 100 also rapidly dissipates cabin heat 225. In particular, cabin heat 225 rises to the top of the cabin 220 (a well known thermodynamic principle) and contacts the evaporator portion 120 of the heat pipe structure 100. This causes the fluid in the wick structure 110 to evaporate and take gaseous form and travel upward. As the gas reaches the condenser section 130 of the heat pipe structure 100 it returns to liquid form, and the liquid returns to the wick structure 110 as is well known in the art. In this manner, cabin heat 225 is removed from the cabin.

The heat pipe structure 100 dissipates cabin heat 225 even more rapidly when the car is in motion. In particular, when the automobile 200 is moved in direction 240, air passes across the roof 210 of the automobile at a specified rate dependent upon the speed of the automobile. The air passing across the roof 210 serves to cool the condenser section 130 of the heat pipe structure 100 and also serves to remove any cabin heat 225 which rises towards the roof. Thus, depending upon the external air temperature at the roof 210, more or less cabin heat 225 can be removed from the automobile 200.

Experiments performed by the present applicants have shown that with an internal cabin temperature of approximately 80° C., and an external air temperature of approximately 37° C., approximately 400 watts of power can be transferred from the cabin 220 utilizing the heat pipe structure 100 according to the exemplary embodiment of the present invention.

FIG. 3 shows a cross section of the heat pipe 100, taken along lines 3-3 in FIG. 1(a). As will be understood, the housing 105 of the heat pipe structure 100 is formed by lower and upper housing layers 121, 131. As stated above, these layers are preferably formed of metal such as Copper, but may be formed from any suitable material known to those skilled in the art. The wick structure 110 is disposed on the lower layer 121, and a vapor space 115 is disposed therebetween. As is known in the art, the vapor space 115 comprises an area in which vapor evaporated at the heat input point (i.e., evaporator side 120) can migrate to cooler parts of the heat pipe structure (i.e., condenser side 130) to be condensed.

The wick structure 110 are preferably made of Copper felt wick which is in a range from 0.010 to 0.040 inch thick. This Copper felt is typically constructed of fibers which are 0.00002 inch in diameter, and 0.20 inch in length, wherein Copper forms 20-60% of the wick structure 115 volume. The wick structure 110 is held in place by a partial vacuum created when the heat pipe structure 100 is operating below the working fluid's (e.g., water) normal boiling point. It is also possible to melt, press or otherwise adhere the wick structure 110 to the housing layer 121, thereby improving the thermal conductance between the housing layer and the adjoining wick structure. In an alternative construction, one or more layers of fine mesh screen can also serve as wick structure 110.

Thus, the heat pipe structure 100 described above provide for a thin, flexible and reliable heat pipe which may be utilized to control the interior temperature of an automobile. The heat pipe structure 100 may also include a layer of adhesive applied to either side thereof (e.g., on either or both of housing layers 121, 131) for allowing easy placement of the heat pipe structure against a heat producing member.

In an alternative embodiment of the present invention, an additional compartment situated between the cabin 220 and the heat pipe structure 100 may be added for increasing temperature dissipation capabilities. For example, an additional compartment including fans disposed at either end thereof may be used to more efficiently move heated cabin air 225 across the across the evaporator portion 120 of the heat pipe structure 100.

In another alternative embodiment, the heat pipe structure 100 may include heat-dissipating fins as are well known in the art for further increasing the heat dissipation capabilities of the heat pipe structure by increasing the surface area of the heat pipe structure. Preferably, such fins would be disposed on the evaporator section 120 of the heat pipe 100.

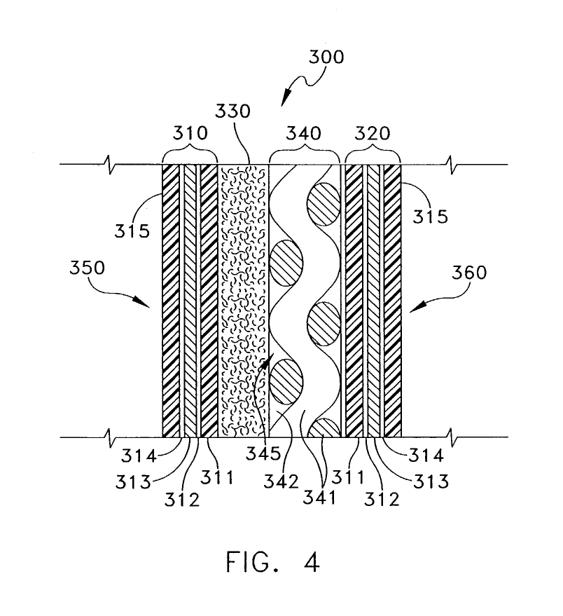

FIG. 4 shows a cross section of the heat pipe structure 300 according to a second exemplary embodiment of the present invention. The heat pipe structure 300 is similar to the heat pipe structure 100 shown in FIG. 3, except that instead of single-layer housing wall layers (e.g., 121, 131 in FIG. 3), the heat pipe structure 300 includes lower and upper housing walls 310, 320 which each include multiple layers. The heat pipe structure 300 also includes a wick 330, and a separator layer 340 (explained below) for maintaining a gap or vapor space 345 between the wick and the upper housing wall 320. Like the heat pipe structure 100 described above, the heat pipe structure 300 includes both an evaporator section 350, and a condenser section 360.

The wick structure 330 is disposed on lower housing wall 310, and the separator layer 340 is in turn disposed on the wick structure 330. The separator layer 340 is constructed of one or more layers of either metal or plastic screen, although plastic is preferred in that it makes the heat pipe structure 300 more flexible. The function of the separator layer 340 is to provide interconnected spaces 342 within the heat pipe structure 300 to function as a vapor space 345 within which vapor evaporated at the heat input point (i.e., evaporator side 350) can migrate to cooler parts of the heat pipe structure (i.e., condenser side 360) to be condensed. In the second exemplary embodiment of the present invention, separator layer 340 is formed of 10-mesh polypropylene screen with 0.030 inch wire thickness, although a screen formed of any suitable material (and of any suitable wire thickness) may be utilized. Since wires 341 of the separator layer 340 overlap and contact one another, the screen provides a minimum separation of about 0.040 inch between the wick structure 330 and the separator layer.

Lower and upper housing walls 310, 320 are formed as laminates which include five separate layers, including a first reinforcing layer 311 (preferably made of polypropylene), a first adhesive layer 312, a metal layer 313, a second adhesive layer 314, and a second reinforcing layer 315 (also preferably made of polypropylene). In the exemplary embodiment, the reinforcing layers 311, 315 are approximately 0.004 inch thick. The reinforcing layers 311, 315 function both to support the metal layer 313, and to bond the lower and upper walls 310, 320 together to form the heat pipe structure 300. The bond is accomplished by pressing the edges of the walls 310, 320 together while heat is applied, a process well known to those skilled in the art.

As will be understood by those skilled in the art, metal layer 313 is attached to the first reinforcing layer 311 by the first adhesive layer 312. In the exemplary embodiment, metal layer 313 comprises a Copper foil which is approximately 0.001 inch thick, and first adhesive layer 312 is approximately 0.0005 inch thick and made of polyethylene terepthalate. The second reinforcing layer 315 is attached to the metal layer 313 by the second adhesive layer 314. In the exemplary embodiment, second reinforcing layer 315 is 0.004 inch thick and made of polypropylene, and second adhesive layer 312 is approximately 0.0005 inch thick and made of polyethylene terepthalate.

The metal layers 313 of the housing walls 310, 320 act as barriers to prevent gas leakage into the vacuum space 345 of the heat pipe structure 300. The metal layers 313 also serve to prevent the vapor pressure inside the vacuum space 345 from leaking out of the heat pipe structure 300.

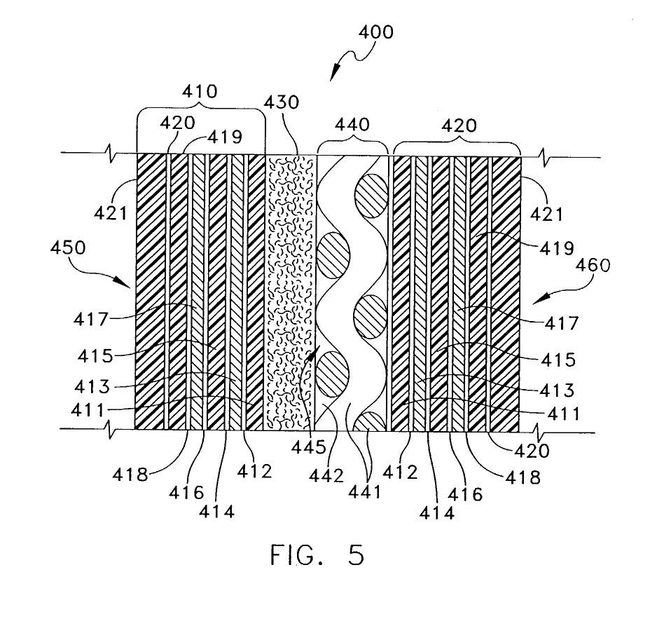

FIG. 5 shows a cross section of the heat pipe structure 400 according to a third exemplary embodiment of the present invention. The heat pipe structure 400 is similar to the heat pipe structure 100 shown in FIG. 3, except that instead of single-layer housing wall layers (e.g., 121, 131 in FIG. 3), the heat pipe structure 400 includes lower and upper housing walls 410, 420 which each include multiple layers. The heat pipe structure 400 also includes a wick 430, and a separator layer 440 (explained below) for maintaining a gap or vapor space 445 between the wick and the upper housing wall 420. Like the heat pipe structure 100 described above, the heat pipe structure 400 includes both an evaporator section 450, and a condenser section 460.

The wick structure 430 is disposed on lower housing wall 410, and the separator layer 440 is in turn disposed on the wick structure 430. The separator layer 440 is constructed of one or more layers of either metal or plastic screen, although plastic is preferred in that it makes the heat pipe structure 400 more flexible. The function of the separator layer 440 is to provide interconnected spaces 442 within the heat pipe structure 400 to function as a vapor space 445 within which vapor evaporated at the heat input point (i.e., evaporator side 450) can migrate to cooler parts of the heat pipe structure (i.e., condenser side 460) to be condensed. In the third exemplary embodiment of the present invention, separator layer 440 is formed of 10-mesh polypropylene screen with 0.030 inch wire thickness, although a screen formed of any suitable material (and of any suitable wire thickness) may be utilized. Since wires 441 of the separator layer 440 overlap and contact one another, the screen provides a minimum separation of about 0.040 inch between the wick structure 430 and the separator layer.

Lower and upper housing walls 410, 420 are formed as laminates which include nine separate layers, including a first reinforcing layer 411 (preferably made of polypropylene), a first adhesive layer 412, a metal layer 413, a second adhesive layer 414, a second reinforcing layer 415 (also preferably made of polypropylene), a third adhesive layer 416, a second metal layer 417, a fourth adhesive layer 418, a third reinforcing layer 419 (preferably made of plastic), a fifth adhesive layer 420, and a fourth reinforcing layer 421 (also preferably made of polypropylene).

In the exemplary embodiment, the reinforcing layers 411, 415, 419 and 421 function both to support the metal layers 413, 417, and to bond the lower and upper walls 410, 420 together to form the heat pipe structure 400. The bond is accomplished by pressing the edges of the walls 410, 420 together while heat is applied, a process well known to those skilled in the art.

The metal layers 413 and 417 of the housing walls 410, 420 act as barriers to prevent gas leakage into the separator layer 440 of the heat pipe structure 400. The metal layers 413, 417 also serve to prevent vapor pressure inside the vapor space 445 from leaking out of the heat pipe structure 400.

Moreover, the reliability of the seal is increased by the use of two metal barrier layers (e.g., first and second metal layers 413, 417), as opposed to just one (e.g., housing layer 121 in FIG. 3; metal layers 313 in FIG. 4). Additionally, since metal foil sheets occasionally have random pinholes therethrough (due to manufacturing defects), the use of two metal foil layers (e.g., first and second metal layers 413, 417) reduces the likelihood of leaks because of the very low probability that one or more such pinholes in separate metal foil sheets will align in the final structure.

Thus, the use of two metal layers 413, 417, and a plurality of strengthening plastic layers 411, 415, 419, 421 for support produces a very reliable and very flexible heat pipe structure. The heat pipe structure 400 may also include a third layer of adhesive applied to either side thereof (e.g., on either or both of fourth reinforcing layers 421) for allowing easy placement of the heat pipe structure against a heat producing member.

With any of the heat pipe structures 100, 300, 400 described above, additional coatings may be applied to either or both of the heat pipe housing outer layers (i.e., layers 121, 131 in FIG. 3; layers 315 in FIG. 4; layers 421 in FIG. 5) to facilitate various applications. For example, in some applications it may be desirable to coat the outer layers with an electrically insulating layer to prevent the heat pipe from creating shorts across adjacent electrical connectors.

Further more, as described above with reference the heat pipe structure 100, heat pipe structures 300 and 400, may include heat-dissipating fins as are well known in the art for further increasing the heat dissipation capabilities of the heat pipe structures by increasing the surface area of the heat pipe structures. Preferably, such fins would be disposed on the evaporator sections 350, 450 of the heat pipe structures.

Although the invention has been described in terms of exemplary embodiments, it is not limited thereto. Rather, the appended claims should be construed broadly, to include other variants and embodiments of the invention which may be made by those skilled in the art without departing from the scope and range of equivalents of the invention.

What is claimed is:

1. A heat pipe system for an automobile comprising:
a separator layer;
at least one wick layer in contact with the separator layer;
at least two outer walls enclosing the separator layer and the at least one wick layer, one of the at least two outer walls being spaced away from the at least one wick layer to form a vapor space therebetween.

2. The heat pipe system of claim 1, wherein the at least two outer walls are formed of plastic.

3. The heat pipe system of claim 1, wherein the at least two outer walls comprise:
a first reinforcing layer; and,
a first metal layer secured to the first reinforcing layer by a first adhesive layer.

4. The heat pipe system of claim 1, wherein the at least two outer walls comprise:
a first reinforcing layer; and,
a first metal layer disposed adjacent to the first reinforcing later.

5. The heat pipe system of claim 4, wherein the first reinforcing layer comprises a layer of polypropylene.

6. The heat pipe system of claim 4, wherein the at least two outer walls further comprise:
a second reinforcing layer disposed adjacent to the first reinforcing later.

7. The heat pipe system of claim 6, wherein the second reinforcing layer comprises a layer of polypropylene.

8. The heat pipe system of claim 4, wherein the at least two outer walls further comprise:
a second reinforcing layer secured to the reinforcing layer by a second adhesive layer.

9. The heat pipe system of claim 1, wherein another of the at least two outer walls is disposed adjacent to the at least one wick layer.

10. The heat pipe system of claim 1, wherein said one of the at least two outer walls is fixedly attached to a roof of the automobile.

11. The heat pipe system of claim 1, further comprising a working liquid disposed inside the heat pipe structure.

12. The heat pipe system of claim 1, further comprising heat dissipating fins disposed on one of the at least two outer walls.

13. The heat pipe system of claim 1, wherein the separator layer comprises at least one wire mesh layer.

14. The heat pipe system of claim 1, wherein the at least two outer walls comprise:
a first reinforcing layer;
a first metal layer disposed adjacent the first reinforcing layer;
a second reinforcing layer disposed adjacent the first metal layer;
a second metal layer disposed adjacent the second reinforcing layer;
a third reinforcing layer disposed adjacent the second metal layer;
a fourth reinforcing layer disposed adjacent the third reinforcing layer.

15. The heat pipe system of claim 1, wherein the at least two outer walls comprise:
a first reinforcing layer;
a first metal layer secured to the first reinforcing layer by a first adhesive layer;
a second reinforcing layer;
a second metal layer secured to the second reinforcing layer by a second adhesive layer;
a third reinforcing layer secured to the second metal layer by a third adhesive layer;
a fourth reinforcing layer secured to the third reinforcing layer by a fourth adhesive layer.

16. An automobile comprising:
a roof overlying a cabin area;
a heat pipe disposed between the cabin area and the roof of the automobile, said heat pipe comprising a separator layer, at least one wick layer in contact with the separator layer, at least two outer walls enclosing the separator layer and the at least one wick layer, at least one of the at least two outer walls being spaced away from the at least one wick layer to form a vapor space therebetween.

17. The automobile of claim 16, wherein the at least two outer walls are formed of plastic.

18. The automobile of claim 16, wherein the at least two outer walls further comprise:
a first reinforcing layer; and,
a first metal layer secured to the first reinforcing layer by a first adhesive layer.

19. The automobile of claim 18, wherein the first reinforcing layer comprises a layer of polypropylene.

20. The heat pipe system of claim 18, wherein the at least two outer walls further comprise:
a second reinforcing layer disposed adjacent to the first reinforcing later.

21. The heat pipe system of claim 20, wherein the second reinforcing layer comprises a layer of polypropylene.

22. The heat pipe system of claim 18, wherein the at least two outer walls further comprise:
a second reinforcing layer secured to the reinforcing layer by a second adhesive layer.

23. The automobile of claim 16, wherein another of the at least two outer walls is disposed adjacent to the at least one wick layer.

24. The automobile of claim 16, wherein said one of the at least two outer walls is fixedly attached to the roof of the automobile.

25. The automobile of claim 16, further comprising an additional compartment disposed between the heat pipe and the cabin area.

26. The automobile of claim 16, wherein the separator layer comprises at least one wire mesh layer.

27. A method for cooling a passenger compartment of an automobile, comprising the steps of:
disposing a heat pipe between the passenger compartment and a roof of the automobile.

28. The method of claim 27, comprising the further steps of:
permitting heated air within the passenger compartment to contact an evaporator portion of the heat pipe; and,
permitting solar radiation impinging on the roof of the automobile to contact a condenser portion of the heat pipe.

29. A cooling system comprising:
a passive heat removal system disposed in an automobile between a passenger compartment and a roof of the automobile.

30. The cooling system of claim 29, wherein the passive heat removal system comprises a heat pipe including a separator layer, at least one wick layer in contact with the separator layer, at least two outer walls enclosing the separator layer and the at least one wick layer, at least one of the at least two outer walls being spaced away from the at least one wick layer to form a vapor space therebetween.
